(19) United States
(12) Patent Application Publication
(10) Pub. No.: US 2019/0126705 A1
(43) Pub. Date: May 2, 2019

(54) CONNECTION ARRANGEMENT FOR A TRANSVERSE LEAF SPRING, AND TRANSVERSE LEAF SPRING AND BEARING DEVICE

(71) Applicant: ZF Friedrichshafen AG, Friedrichshafen (DE)

(72) Inventor: Mathias SCHRAMM, Bamberg (DE)

(73) Assignee: ZF Friedrichshafen AG, Friedrichshafen (DE)

(21) Appl. No.: 16/309,671

(22) PCT Filed: May 15, 2017
(86) PCT No.: PCT/EP17/61552

§ 371 Date: Dec. 13, 2018

(30) Foreign Application Priority Data
Jun. 17, 2016 (DE) DE102016210888.3

(51) Int. Cl. B60G 11/10; B60G 11/08; F16F 1/368

(52) U.S. Cl. CPC B60G 11/10; B60G 11/08; F16F 1/3683; B60G 2206/7101; B60G 2202/114; B60G 2204/418; B60G 2206/428; B60G 2204/121

(57) ABSTRACT

The disclosure relates to a connecting assembly for a transverse leaf spring that has a transverse leaf spring made of fiber-reinforced plastic and a bearing device, which encompasses the transverse leaf spring at the bearing point in a form fitting manner, wherein the transverse leaf spring has a ribbed structure at the bearing point, and the bearing device has notches, in which the ribbed structure engages in a form fitting manner.

The disclosure also relates to a transverse leaf spring and a bearing device, suitable for forming such a connecting assembly.

The disclosure relates to a connecting assembly for a transverse leaf spring that has a transverse leaf spring made of fiber-reinforced plastic and a bearing device that encompasses the transverse leaf spring at a bearing point in a form fitting manner.

The disclosure also relates to a transverse leaf spring made of fiber-reinforced plastic and a bearing device for connecting or mounting a transverse leaf spring to a motor vehicle.

A transverse leaf spring made of a fiber composite is known from DE 10 2015 218 055, by the same applicant. The flat bar-like transverse leaf spring is installed in the region of a vehicle axle, substantially transverse to the vehicle. The transverse leaf springs are connected to the wheel bearings or the like by means of so-called guide bearings at their ends extending toward the vehicle wheels. The transverse leaf springs are connected in the middle directly to the vehicle body, or a subframe or the like, by means of so-called center bearings.

The embodiment of a center bearing device shown in FIG. 7 of DE 10 2015 218 055 A1 comprises two half-shells that can be connected to one another, which encompass the transverse leaf spring at the bearing point in a form fitting manner. The transverse leaf spring is thicker at the bearing point, where it is encompassed by the half-shells (see FIG. 6), which can slip out of the bearing device when a specific lateral force acting along the length of the spring is exceeded (e.g. when colliding sideways with a curb), in order to ensure a controlled failure. The thicker sections of the transverse leaf spring at the center bearing points is created during production thereof by adding further small fiber layers in a complex process.

The fundamental object of the disclosure is to create a connecting assembly for attaching or fastening a transverse leaf spring made of fiber composite or fiber-reinforced plastic, which enables a controlled failure, the components of which, in particular the transverse leaf spring itself, can be produced easily, or with little production effort.

This problem is solved with a connecting assembly according to the disclosure corresponding to claim 1. The disclosure relates to a transverse leaf spring made of fiber-reinforced plastic and a bearing device or retention device suitable for creating a connecting assembly according to the disclosure, described in the coordinate independent claims. Preferred developments and designs of the disclosure can be derived analogously for all of the subject matter of the disclosure from the dependent claims, the following description, and the drawings.

The connecting assembly according to the disclosure is characterized in that the transverse leaf spring has a ribbed structure at the at least one relevant bearing point, and the bearing device has notches in which the ribs engage in a form fitting manner.

In the framework of the disclosure, a ribbed structure comprises numerous parallel ribs or webs protruding from the transverse leaf spring. Notches, in the framework of the disclosure, are recesses or grooves formed on the inner walls of the bearing device, designed and disposed for a form fitting engagement with the ribs (similar to a tongue and groove connection). This means that the ribs on the transverse leaf spring and the notches on the bearing device correspond to one another. The ribs and notches are preferably formed such that a comb-like engagement is obtained. The connecting assembly according to the disclosure can also be referred to as an attachment system.

The form fit between the transverse leaf spring and the bearing device that transfers the lateral forces, which is obtained in the prior art by a complex method for making the leaf shape thicker at the bearing point, is replaced according to the disclosure by a ribbed structure, which engages in the notches on the bearing device (using the tongue and groove principle).

The ribbed structure (or the ribs thereof) and the notches are preferably transverse to the length (longitudinal direction of the spring) of the transverse leaf spring. As a result of the form fitting connection, lateral forces acting in the longitudinal direction of the spring can be absorbed, as with the prior art solution, i.e. these forces can be transferred from the transverse leaf spring to the bearing device and back. If a defined lateral force is exceeded, the ribs, or webs of the ribbed structure break off, and the transverse leaf spring slips longitudinally through the bearing device. The ribbed structure (or the ribs thereof) thus forms a predetermined breaking point, which ensures a controlled failure. The ribbed structure is substantially easier to produce, however, in particular in comparison with the thickening in the prior art, as shall be explained below.

The transverse leaf spring is preferably formed such that the ribs are an integral part thereof, wherein the ribbed structure is made of only the plastic matrix material (the fiber composite or fiber-reinforced plastic), such that there are no reinforcing fibers therein. If a thermosetting resin is used, the ribs are made only of the thermosetting resin. The ribs or webs are only on the surface of the transverse leaf spring. These can be formed directly in the tool (e.g. an RTM tool) during the production process for the transverse leaf spring, without fibers or fiber layers fraying off in an unfavorable manner. The addition of further fiber layers to the bearing point is unnecessary, thus substantially simplifying the production process, in particular the pre-shaping process.

The ribs can be formed on just a section of the relevant bearing point, e.g. on the upper surface or lower surface of the transverse leaf spring. It is preferred, however, that the ribbed structure is formed over the entire circumference of the transverse leaf spring at the bearing point. The notches on the bearing device are formed such that a form fitting engagement, in particular a comb-like engagement, can be obtained.

The bearing device, preferably made of metal, can be configured such that the transverse leaf spring is supported directly therein. Alternatively, it can be supported indirectly, in that the bearing device has a separate bearing sleeve, for example, in which the notches are then formed. This bearing sleeve is an easily produced molded component made through plastic injection, a light metal component made through pressure die casting, or the like.

The transverse leaf spring claimed in the first coordinate independent claim is formed as a flat bar-like spring element, and made from a fiber-reinforced plastic. This transverse leaf spring is characterized according to the disclosure in that the center bearing points (in the middle of the transverse leaf spring) have ribs that are designed to engage in a form fitting manner in corresponding bearing devices (center bearing). The transverse leaf spring preferably has two such center bearing points.

The bearing device for attaching a transverse leaf spring claimed in the second coordinate independent claim, a center bearing device in particular, has two half-shells that can be connected to one another, which encompass the transverse leaf spring at the bearing point. The half-shells are made of metal, by way of example. According to the disclosure, at least one of the half-shells has notches on its inner wall (facing the transverse leaf spring), in which the ribbed structure formed on the transverse leaf spring can engage.

The disclosure shall be explained in greater detail below with reference to the drawings. The features shown in the drawings, or explained below, can be general features of the disclosure, or further developments of the disclosure, independently of any feature combinations.

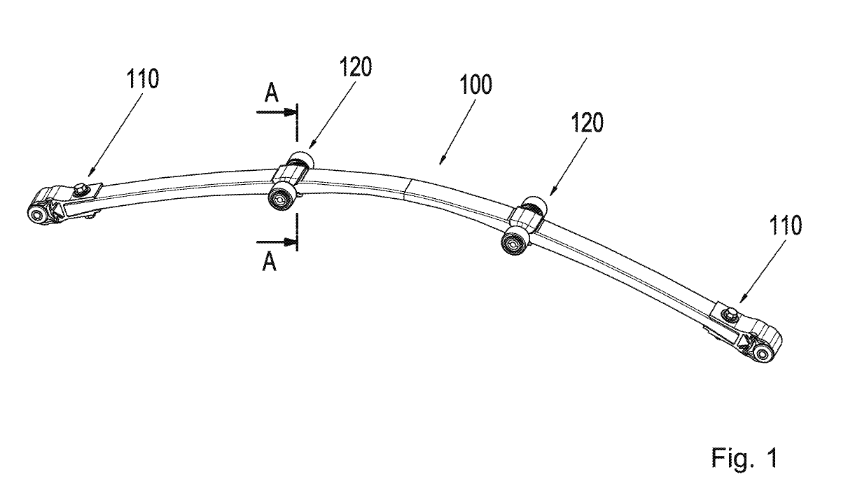

FIG. 1 shows a perspective view of a transverse leaf spring for a motor vehicle.

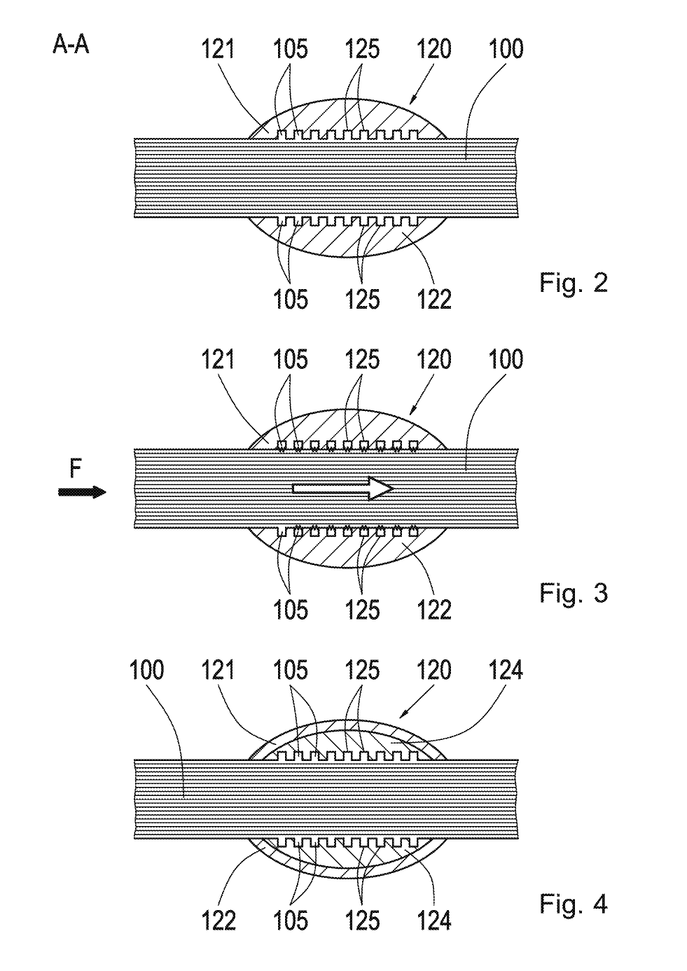

FIG. 2 shows a connecting assembly for attaching the transverse leaf spring in FIG. 1 to a motor vehicle, in a schematic sectional view.

FIG. 3 illustrates the controlled failure at the connecting assembly in FIG. 2.

FIG. 4 shows another embodiment possibility for a connecting assembly, analogous to the illustration in FIG. 2.

The transverse leaf spring 100 shown in FIG. 1 is a flat bar-like spring element made of a fiber-reinforced plastic (e.g. GFRP). The transverse leaf spring 100 is installed transverse to the direction of travel for the motor vehicle. The ends are connected to the wheel bearings by guide bearings 110. The transverse leaf spring 100 is connected at the middle to the vehicle body by means of a center bearing 120. The two center bearings or center bearing devices 120 are disposed symmetrically on either side of the middle of the transverse leaf springs 100.

FIG. 2 shows the connecting assembly at one of the center bearings 120 in a sectional view cut along the line A-A indicated in FIG. 1. The bearing device that forms the center bearing 120 has two half-shells 121 and 122 that are connected to one another, which collectively form a retention device, and encompass the transverse leaf spring 100 at the bearing point in a form fitting manner. The transverse leaf spring 100, reinforced with numerous fiber layers (as indicated by the shading) has a ribbed structure 105 at the bearing point. The individual ribs, or webs, of the ribbed structure 105 have no reinforcement fibers, and are made only of a plastic matrix material, in particular a cured thermoplastic resin (pure resin). The cross section geometry of the individual ribs shown therein is only by way of example.

The bearing device 120, or the half-shells 121 and 122 thereof have corresponding notches 125, in which the ribbed structure 105 engages in a comb-like manner, such that an incut form fit is obtained between the transverse leaf spring 100 and the bearing device 120. As a result, lateral forces acting in the longitudinal direction of the spring can also be absorbed at the center bearing 120 (the same applies to the other center bearing 120). The transverse leaf spring 100 can thus also assume wheel guiding functions.

The ribbed structure 105 is formed on the transverse leaf spring 100 (e.g. by the width of the ribs as well as the number, distribution and configuration of the ribs) such that the ribs thereof break, or break off when a defined lateral force F has been exceeded (e.g. by colliding strongly against a curb), and the transverse leaf spring 100 slips through the bearing device 120, as indicated in FIG. 2 by the arrows. The ribbed structure 105 thus has an integrated predetermined breaking function, in order to ensure a controlled failure. The property of the pure resin areas (i.e. matrix material, without reinforcing fibers) of a fiber composite material, whereby significantly less force or load can be absorbed than in reinforced areas, is exploited here. The optimal design of the ribbed structure 105 can be determined by taking into account the maximum lateral force F that can be absorbed, e.g. through calculation, simulation and/or testing.

FIG. 3 shows an embodiment in which the transverse leaf spring 100 is not directly encompassed by the half-shells 121 and 122 of the bearing device 120, but rather, indirectly by means of a bearing sleeve (or adapter) 124 inserted therebetween, in which the notches 125 are also formed in order to receive the ribbed structure 105. The bearing sleeve 124 can be formed as a single piece, or from numerous pieces, and can also be made of plastic.

### REFERENCE SYMBOLS

100 transverse leaf spring
105 ribbed structure
110 guide bearing
120 center bearing
121 half-shell
122 half-shell
124 bearing sleeve, adapter
125 notches
F lateral force

1. A connecting assembly for a transverse leaf spring comprising:
a transverse leaf spring made of fiber-reinforced plastic, and
a bearing device that encompasses the transverse leaf spring at a bearing point in a form fitting manner,
wherein the transverse leaf spring has a ribbed structure at the bearing point and the bearing device has notches, in which the ribbed structure engages in a form fitting manner.

2. The connecting assembly according to claim 1, wherein the ribbed structure and the notches are transverse to a longitudinal direction of the transverse leaf spring.

3. The connecting assembly according to claim 1, wherein there is a comb-like engagement between the ribbed structure on the transverse leaf spring and the notches on the bearing device.

4. The connecting assembly according to claim 1, wherein the transverse leaf spring is formed such that the ribbed structure is an integral part thereof, wherein the ribbed structure is made only of the plastic matrix material of the fiber-reinforce plastic.

5. The connecting assembly according to claim 1, wherein the ribbed structure is only formed on a portion of the bearing point.

6. The connecting assembly according to claim 1, wherein the ribbed structure is formed on the entire circumference of the bearing point.

7. The connecting assembly according to claim 1, wherein the bearing device has a separate bearing sleeve, in which the notches are formed.

8. A transverse leaf spring for a motor vehicle, which is formed as a flat bar-like spring element and produced from a fiber-reinforced plastic, further comprising center bearings that have ribbed structures for a form fitting engagement in corresponding bearing devices.

9. A center bearing device for attaching a transverse leaf spring to a motor vehicle, wherein the center bearing device has two half-shells that can be connected to one another, which encompass the transverse leaf spring at a bearing point in a form fitting manner, wherein at least one of the half-shells has notches on its inner wall.

10. The center bearing device according to claim 9, wherein both half-shells have notches on their inner walls.

11. The transverse leaf spring according to claim 8, wherein the bearing devices have notches to engage the ribbed structures.

12. The connecting assembly according to claim 1, wherein the ribbed structure is made only of the plastic matrix material of the fiber-reinforce plastic and the ribbed structure is configured to fracture when a predetermined lateral force has been exceeded.

13. The connecting assembly according to claim 1, wherein the ribbed structure comprises numerous parallel ribs protruding from the transverse leaf spring.

14. The connecting assembly according to claim 1, wherein the notches comprise recesses formed on the inner walls of the bearing device.

15. The connecting assembly according to claim 1, wherein the ribbed structure is made only of thermosetting resin.

16. The connecting assembly according to claim 15, wherein the ribbed structure has no reinforcement fibers.

17. The connecting assembly according to claim 4, wherein the ribbed structure has no reinforcement fibers.

18. The connecting assembly according to claim 1, wherein the ribbed structure is only on the surface of the transverse leaf spring.

19. The connecting assembly according to claim 1, wherein the ribbed structure is formed on an entire circumference of the transverse leaf spring at the bearing point.

20. The transverse leaf spring according to claim 8, wherein the ribbed structures are made only of a plastic matrix material of the fiber-reinforce plastic and the ribbed structures are configured to fracture when a predetermined lateral force has been exceeded.
